(19) United States
(12) Patent Application Publication
(10) Pub. No.: US 2016/0314351 A1
(43) Pub. Date: Oct. 27, 2016

(54) EXTENDING GENERIC BUSINESS PROCESS MANAGEMENT WITH COMPUTER VISION CAPABILITIES

(71) Applicant: Xerox Corporation, Norwalk, CT (US)

(72) Inventors: Adrian Corneliu Mos, Meylan (FR); Adrien Gaidon, Grenoble (FR); Eleonora Vig, Grenoble (FR)

(21) Appl. No.: 14/697,167

(22) Filed: Apr. 27, 2015

(51) Int. Cl. G06K 9/00; H04N 7/18; G06F 3/0484; G06K 9/62

(52) U.S. Cl. CPC G06K 9/00711; G06K 9/00201; G06K 9/00362; G06K 9/00986; G06K 9/62; H04N 7/181; G06F 3/0484

(57) ABSTRACT

A graphical user interface (GUI) of a business process management (BPM) system is provided to construct a process model that is displayed on a graphical display device as a graphical representation comprising nodes representing process events, activities, or decision points and including computer vision (CV) nodes representing video stream processing, with flow connectors defining operational sequences of nodes and data flow between nodes of the process model. The process model is executed to perform a process represented by the process model including executing CV nodes of the process model by performing video stream processing represented by the CV nodes of the process model. The available CV nodes include a set of video pattern detection nodes, and a set of video pattern relation nodes defining a video grammar of relations between video patterns detectable by the video pattern detection nodes.

### BACKGROUND

The following relates to the Business Process Management (BPM) arts, computer vision (CV) arts, and related arts.

Video cameras are ubiquitous at many commercial sites, government facilities, non-profit organization worksites, and the like. Video cameras are commonly used for diverse tasks such as security monitoring (i.e. “security cameras”), facility usage monitoring, traffic enforcement, video identification systems (for identifying persons or objects), manufacturing article inspection (e.g., “machine vision” systems used for quality control purposes), and so forth. Video cameras are powerful devices because they acquire tremendous amounts of data in a continuous fashion (e.g. 30 frames/sec in some commercial video cameras), and because video mimics visually oriented human perception.

However, video cameras have some disadvantages as monitoring tools. Complex image and/or video processing is usually required in order to extract useful information from the continuous video data stream. Moreover, the close mimicking of human perception can, paradoxically, be deceptive as video content can be misinterpreted by a human viewer. For example, it is known that human visual perception tends to detect faces and human shapes in video content, even where none are actually present. Shadows or other lighting artifacts can also be misinterpreted. The nature of video analysis also tends to be statistical and uncertain, as statistical image classification techniques are usually employed to detect persons, objects, or other features of interest.

In view of these difficulties, automated computer vision systems tend to be restricted to narrowly tailored tasks. For example, automated computer vision systems are used in manufacturing production lines, where the camera can be precisely positioned to image products passing through the production line from a specific vantage point. Automated camera-based traffic enforcement is also common, where again the camera can be precisely positioned to image the vehicle (and more particularly its license plate) in a consistent way from vehicle to vehicle. Repurposing of such narrowly tailored video systems for other tasks is difficult.

For more complex tasks, or for tasks having low margin of error, automated systems are typically eschewed in favor of manual monitoring of the video feed. For example, a security camera feed is commonly observed by a security guard to detect possible intruders or other security issues. Manual approaches are labor-intensive, and there is the potential for the human being monitoring the video feed to miss an important event.

In sum, although video cameras are commonly available input devices, they are difficult to reliably leverage for diverse applications. Automated video monitoring systems tend to be single-purpose computer vision systems that are not amenable to re-purposing for other tasks. Manually monitored video feeds have reduced reliability due to the possibility of human error, and are difficult or impossible to integrate with automated systems.

Systems, apparatuses, processes, and the like disclosed herein overcome various of the above-discussed deficiencies and others.

### BRIEF DESCRIPTION

In some embodiments disclosed herein, a Business Process Management (BPM) system comprises a graphical display device, at least one user input device, and at least one processor programmed to: implement a BPM graphical user interface (GUI) enabling a user to operate the at least one user input device to construct a process model that is displayed by the BPM GUI on the graphical display device, the BPM GUI providing (i) nodes to represent process events, activities, or decision points including computer vision nodes to represent video stream processing and (ii) flow connectors to define operational sequences of nodes and data flow between nodes; implement a BPM engine configured to execute a process model constructed using the BPM GUI to perform a process represented by the process model; and implement a computer vision engine configured to execute a computer vision node of a process model constructed using the BPM GUI by performing video stream processing represented by the computer vision node. The the BPM GUI may display the process model using Business Process Model Notation (BPMN) to represent the nodes and flow connectors and further using computer vision extension notation to represent computer vision nodes. In some embodiments, the BPM GUI provides computer vision nodes including a plurality of video pattern detection nodes for different respective video patterns, and the computer vision engine is configured to execute a video pattern detection node by applying a classifier trained to detect a video pattern corresponding to the video pattern detection node in a video stream that is input to the video pattern detection node via a flow connector. The BPM GUI may further provide computer vision nodes including a plurality of video pattern relation nodes designating different respective video pattern relations, and the computer vision engine is configured to execute a video pattern relation node by determining whether two or more video patterns detected by execution of one or more video pattern detection nodes satisfy the video pattern relation designated by the video pattern relation node.

In some embodiments disclosed herein, a non-transitory storage medium stores instructions readable and executable by an electronic system including a graphical display device, at least one user input device, and at least one processor to perform a method comprising the operations of: (1) providing a graphical user interface (GUI) by which the at least one user input device is used to construct a process model that is displayed on the graphical display device as a graphical representation comprising (i) nodes representing process events, activities, or decision points and including computer vision nodes representing video stream processing and (ii) flow connectors connecting nodes of the process model to define operational sequences of nodes and data flow between nodes of the process model; and (2) executing the process model to perform a process represented by the process model including executing computer vision nodes of the process model by performing video stream processing represented by the computer vision nodes of the process model. In some embodiments, in the operation (1) the process model is displayed as a graphical representation comprising computer vision nodes selected from: (i) a set of video pattern detection nodes defining a video vocabulary of video patterns of persons, objects, and scenes; and (ii) a set of video pattern relation nodes defining a video grammar of geometrical, spatial, temporal, and similarity relations between video patterns detectable by the set of video pattern detection nodes. In such embodiments, the GUI constructs the process model with the computer vision nodes interconnected by flow connectors in compliance with the video grammar defined by the set of video pattern relation nodes.

In some embodiments disclosed herein, a system comprises a non-transitory storage medium as set forth in the immediately preceding paragraph, and a computer including a graphical display device and at least one user input device, the computer operatively connected to read and execute instructions stored on the non-transitory storage medium.

### BRIEF DESCRIPTION OF THE DRAWINGS

FIG. 1 diagrammatically shows an agile computer vision system that leverages a business process management (BPM) suite to implement user-designed computer vision tasks performed using deployed video cameras.

FIG. 2 illustrates a process including computer vision tasks implemented using the system of FIG. 1.

FIG. 3 diagrammatically illustrates construction and execution by the BPM suite of a process model including computer vision tasks using the system described with reference to FIGS. 1 and 2.

FIG. 4 shows a table presenting some illustrative computer vision nodes that may be provided by an embodiment of the CV extensions of the BPM GUI of the system of FIG. 1.

FIG. 5 shows a diagram of different elements of an illustrative Video Domain-Specific Language (VDSL) which employs a video grammar formalism to organize visual concepts in different entity categories (vocabulary, i.e. detectable video patterns) and video pattern relation categories.

### DETAILED DESCRIPTION

In improvements disclosed herein, a Business Process Management (BPM) system is employed to provide a flexible way to leverage existing or new camera installations to perform diverse computer vision (CV)-based tasks. Conversely, it will be appreciated that various business processes controlled by the BPM system will benefit from CV capability incorporated into the BPM system as disclosed herein.

A Business Process Management (BPM) system is a computer-based system that manages a process including aspects which may cross departmental or other organizational lines, may incorporate information databases maintained by an information technology (IT) department, or so forth. Some BPM systems manage virtual processes such as electronic financial activity; other BPM systems are employed to manage a manufacturing process, inventory maintenance process, or other process that handles physical items or physical material. In the latter applications, the BPM system suitably utilizes process sensors that detect or measure physical quantities such as counting parts passing along an assembly line, measuring inventory, or so forth.

A BPM system is a computer-implemented system that typically includes a graphical BPM modeling component, a BPM executable generation component, and a BPM engine. In a given BPM system implementation, these components may be variously integrated or separated.

The graphical BPM modeling component provides a graphical user interface (GUI) via which a user constructs a model of the business process. A commonly employed BPM graphical representation is Business Process Model [and] Notation (BPMN), in which nodes (called “objects” in BPMN) representing process events, activities, or gateways are connected by flow connectors (called “flow objects” in BPMN). An event is, for example, a catching event which when detected starts a process, or a throwing event generated upon completion of a process. An activity performs some process, task, or work. Gateways are types of decision points. The flow connectors define ordering of operations (i.e. operational sequences), designate message, communication, or data flow, or so forth. As another example, the graphical BPM modeling component may be a custom graphical front end for modeling the business process in the Business Process Execution Language (BPEL). In some implementations, BPMN serves as the graphical front end for generating the BPM model in BPEL. The GUI process graphical representation may optionally include other features such as functional bands (called “swim lanes” in BPMN) grouping nodes by function, executing department, or so forth, or annotations (called “artifacts” in BPMN) that label elements of the BPM model with information such as required data, grouping information, or the like.

The BPM executable generation component converts the graphical BPM model to an executable version that can be read and executed by the BPM engine. Execution of the executable model version by the BPM engine performs the actual process management. It will be appreciated that various BPM system implementations provide varying levels of integration between the graphical BPM modeling component and the BPM executable generation component, and/or between the BPM executable generation component and the BPM engine. For example, the Java-based jBPM open-source engine executes a graphical BPMN model directly. Bonita BPM is an open-source BPM suite which includes a BPMN-compliant GUI and a BPM engine implemented as a Java application programming interface (API). As another example, Stardust Eclipse is another open-source BPM including a BPMN-compliant GUI and a Java-based BPM engine. Many BPM suites are web-based.

The term “Business Process Management” is a term of art reflective of the common use of BPM systems in automating or streamlining manufacturing, inventory, and other processes performed in a commercial setting. It will be appreciated that a BPM system incorporating computer vision as disclosed herein is more generally applicable to any type of process beneficially incorporating or performing computer vision tasks. For example, a city, county, state, or other governmental entity may employ a BPM system with computer vision extensions to perform traffic monitoring or enforcement functionality. As another example, a non-profit environmental advocacy organization may employ a BPM system incorporating computer vision for tasks such as environmental monitoring or automated wildlife monitoring (e.g. raptor nest monitoring). Moreover, the disclosed BPM systems with computer vision extensions may be used to automate or re-purpose new or existing computer vision systems, or may be used to integrate computer vision into other processes.

As disclosed herein, a BPM system can be extended to incorporate computer vision activities performed using video cameras, such as already-available security cameras, inspection cameras for industrial processes, traffic monitoring or enforcement cameras, and so forth. This extension leverages computer vision as a new type of sensor input for process management under a BPM system. However, it will be appreciated that a video camera is far more complex than a typical industrial sensor that provides a discrete value, e.g. a quantity or weight or the like. Leveraging computer vision requires performing video or image processing to derive useful information from the video content. In some embodiments, the BPM system may also manipulate the video camera(s) by operations such as panning, zoom, or the like.

In some disclosed approaches, the BPM system is extended to incorporate computer vision by providing a vocabulary of visual concepts, and a grammar defining interactions of these visual concepts with other visual concepts and/or with other data processed by the BPM system in order to represent complex processes. These building blocks can be combined by composition to construct complex tasks. Advantageously, generic or domain-specific computer vision extension modules such as pedestrian detectors, various object detectors, composition rules (e.g., spatio-temporal relations), and so forth can be re-used, and detectors can be trained using training data across domains. Re-use of generic or domain-specific computer vision extension modules in the BPM system enables computer vision to be integrated with processes managed by BPM, without the need for laborious manual creation of computer vision infrastructure. Disclosed approaches also accommodate the typically high uncertainty associated with video-based observations. While the term computer vision “extension” modules is used herein to reflect an implementation in which an existing BPM system is extended (or retrofitted) to incorporate computer vision capability, it will be appreciated that the disclosed computer vision extension modules may be included in the BPM system as originally constructed.

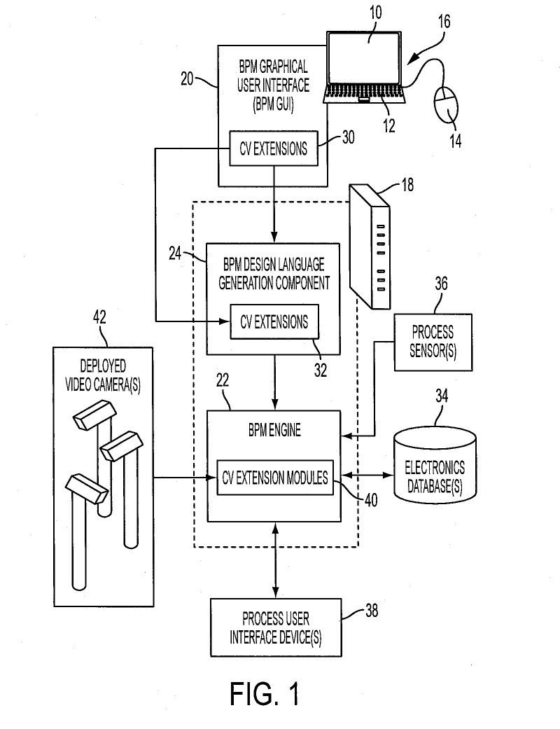

With reference to FIG. 1, a Business Process Management (BPM) system comprises an electronic system that includes a graphical display device 10, at least one user input device 12, 14 (represented for illustrative purposes by a keyboard 12 and a mouse 14) and at least one processor, such as a microprocessor housed in a desktop or notebook computer 16, or a CPU of a network- or Internet-based server 18 or so forth. It will be appreciated that the processing resources may be variously distributed amongst local and/or remote (e.g. cloud-based) computing resources. In some embodiments the local components provide only the user interfacing devices 10, 12, 14 and the one or more processors are located remotely. In the illustrative example, the desktop or notebook computer 16 implements the BPM graphical user interface (GUI) 20 while the server computer 18 executes the BPM engine 22 and an intermediary BPM design language generation component 24. In web-based embodiments, the user interfacing devices 10, 12, 14 may be implemented via the desktop or notebook computer 16 running a web browser and connected with the server 18 via an Internet Protocol (IP) network (e.g. the Internet and/or an IP-compliant local area network), while the remaining BPM processing is performed by the server computer 18. In such web-based embodiments, the processing required to implement the BPM GUI 20 may execute server-side (i.e. on the server 18), client-side (i.e. on the computer 16 running the web browser), or some combination of server- and client-side.

The BPM GUI 20 enables a user to operate the at least one user input device 12, 14 to construct a process model that is displayed by the BPM GUI 20 on the graphical display device 10. The BPM GUI 20 provides (i) nodes to represent process events, activities, or decision points including computer vision nodes to represent video stream processing and (ii) flow connectors to define operational sequences of nodes and data flow between nodes. In the illustrative example, the BPM GUI 20 displays the process model using Business Process Model Notation (BPMN) to represent the nodes and flow connectors, and further uses computer vision (CV) extension notation implemented by CV extensions 30 to represent computer vision nodes.

Depending upon the architecture of the specific BPM suite, the process model may be directly executed by the BPM engine or, as in the illustrative example shown in FIG. 1, an intermediary BPM design language generation component 24 may be provided to convert (e.g. compile) the process model into a design language readable and executable by the BPM engine 22. By way of illustration, the intermediary BPM design language generation component 24 may convert the process model represented in BPMN into a Business Process Execution Language (BPEL) format that is executed by the BPM engine 22. To enable conversion, the BPM design language generation component 24 includes CV extensions 32 to implement the CV nodes of the BPMN process model. Again, it is to be understood that this is merely one illustrative BPM suite architecture—as another example, the BPM engine may receive the process model in BPMN directly, without conversion to BPEL or any other intermediary format. As yet another example, the generation component 24 may be included and output BPEL but the BPM GUI may be a custom GUI that is not BPMN-compliant.

The BPM engine 22 is configured (e.g. the server 18 is programmed) to execute the process model constructed using the BPM GUI 20 (and optionally after format conversion or compilation, e.g. by the generation component 24) to perform the process represented by the process model. The BPM suite 20, 22, 24 may be a conventional BPM suite with suitable modifications as disclosed herein to execute CV functionality. By way of illustrative example, the BPM suite 20, 22, 24 may be an open-source BPM suite such as jBPM, Bonita BPM, or Stardust Eclipse, or a variant (e.g. fork) of one of these BPM suites. If appropriate for executing the process model, the BPM engine 22 may access resources such as various electronic database(s) 34, for example corporate information technology databases storing information on product inventory, sales information, or so forth. If the process managed in accordance with the process model manages a manufacturing process, inventory maintenance process, or other process that handles physical items or physical material, the BPM engine 22 may access various process-specific inputs such as automated sensor(s) 36 (e.g. an assembly line parts counter) or process-specific user input device(s) 38 (e.g. user controls or inputs of a process control computer or other electronic process controller). The interactions between the BPM engine 22 and these various ancillary resources 34, 36, 38 is suitably performed in accordance with existing BPM engine technology, for example as provided in jBPM, Bonita BPM, or Stardust Eclipse BMP suites.

To process computer vision (CV) nodes of the process model, a CV engine 40 is configured (e.g. the server 18 is programmed) to execute a computer vision node of a process model constructed using the BPM GUI 20 by performing video stream processing represented by the computer vision node. The illustrative CV engine 40 is implemented as computer vision extension modules of the BPM engine 22. In other embodiments, the CV engine may be a separate component from the BPM engine that communicates with the BPM engine via function calls or the like. The CV engine 40 operates on video stream(s) generated by one or more deployed video camera(s) 42.

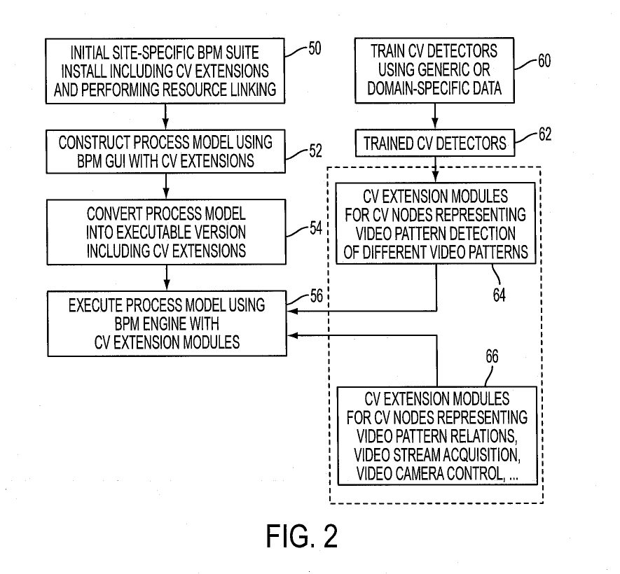

With reference to FIG. 2, BPM processing performed by the BPM system of FIG. 1 is diagrammatically illustrated. In an operation 50, the BPM suite is installed, including installing the BPM suite components 20, 22, 24 and the CV extensions 30, 32, 40. The BPM installation 50 is typically a site-specific installation process that includes linking the various resources 34, 36, 38, 42 to the BPM suite. Typically, the BPM suite installation 50 will be performed by an information technology (IT) specialist with training in the particular BPM suite (e.g. jBPM, Bonita, Stardust Eclipse) being installed. The CV extensions may be integral with the BPM suite (in which case no extra operations may need to be performed to add the CV capability) or the (illustrative) CV extensions 30, 32, 40 may be add-on components that requires additional installation operations to install the CV extensions 30, 32, 40.

In an operation 52, the process model is constructed using the BPM GUI 20. The process modeling operation 52 may be performed by an IT specialist or, due to the intuitive graphical nature of BPMN or other graphical representational graphical user interfaces, may be performed by a non-specialist, such as an assembly line engineer trained in the manufacturing process being modeled but not having substantial specialized BPM training. Various combinations may be employed—for example, the initial process model may be constructed by an IT specialist with BPM training, in consultation with assembly line engineers, and thereafter routine updating of the process model may be performed directly by an assembly line engineer. In constructing the process model, the CV extensions 30 are used as disclosed herein to implement computer vision functions such as detecting patterns and pattern relationships and recognizing more complex events composed of patterns and pattern relationships.

In an operation 54, the constructed process model is converted by the BPM design language generation component 24 into an executable version, including using the CV extensions 32 to convert the CV nodes of the process model. For example, the operation 54 may convert the graphical BPMN process model into an executable BPEL version. It will again be appreciated that in some BPM suite architectures the operation 54 may be omitted as the BPM engine directly executes the graphical process model.

In an operation 56, the process model is executed by the BPM engine 22, with the CV extension modules 40 (or other CV engine) executing any CV nodes of the process model by performing the video stream processing represented by the CV nodes.

The CV extensions disclosed herein provide a high degree of flexibility in constructing a CV process (or sub-process of an overall process model) by leveraging the BPM process modeling approach in which nodes represent process events, activities, or decision points, and flow connectors define operational sequences of nodes and data flow between nodes. In disclosed illustrative embodiments, BPM nodes representing events analogize to a set of video pattern detection nodes defining a video vocabulary of video patterns of persons, objects, and scenes. Likewise, BPM nodes representing activities analogize to a set of video pattern relation nodes defining a video grammar of geometrical, spatial, temporal, and similarity relations between the various video patterns that are detectable by the set of video pattern detection nodes. BPM decision nodes (e.g. BPMN gateways) can be used analogously as in conventional BPM, but operating on outputs of the CV nodes. By thusly breaking the computer vision process down into constituent building blocks, the existing BPM GUI 20 is leveraged (by adding the CV extensions 30) to enable construction of CV processes or sub-processes. Re-use of the CV building blocks (i.e. re-use of the CV nodes) is readily facilitated. In general, video patterns of various types may be detected, such as video patterns of persons, objects, and scenes. Similarly, various geometrical, spatial, temporal, and similarity relations between video patterns may be recognized. For example, the rotation of an object may be recognized by the operations of (1) detecting the object at two successive times in the video stream using a video pattern detector trained to detect the object and (2) recognizing the second-detected instance of the object is a rotated version of the first-detected instance of the object. In another example, compliance or non-compliance with a traffic light can be performed by operations including (1) detecting a vehicle over successive time instances spanning the duration of a detected red traffic light using appropriate pattern detectors and temporal pattern relations, (2) determining the spatial relationship of the vehicle to the red traffic light over the duration of the red light using appropriate spatial pattern detectors, and (3) at a BPM gateway, deciding whether the vehicle obeyed the red traffic light by stopping at the red light based on the determined spatial relationships.

With continuing reference to FIG. 2, aspects relating to the CV extensions are illustrated at the right side of the flow diagram. In operations 60, 62, 64 the video pattern detection nodes are generated. These nodes are suitably trained on annotated training data to detect video patterns of interest. To this end, in operation 60 CV detectors are trained to detect the various video patterns of interest using generic or domain-specific labeled training data in order to generate trained CV detectors 62 for detecting the various video patterns of interest. Using generic training data provides a generally applicable CV detector; however, due to the sometimes strongly domain specific nature of video pattern detection, CV detectors may need to be trained on domain-specific data. For example, a vehicle detector for use in a parking garage may need to be trained separately from one for use on an open road due to the very different lighting conditions in a garage versus an open road. Similarly, different vehicle detectors may need to be trained for different states, countries, or other different locales to account for locale-dependent vehicle models, license plate designs, and so forth. The CV detectors 62 may use any type of image or video classification algorithm that is suitable for the pattern being detected. The CV detector may operation on individual video frames or on video segments, depending on the nature of the pattern to be detected and its expected temporal characteristics. The CV extension modules 64 (or other components of the CV engine 40) implementing video pattern detection nodes comprise the trained CV detectors 62, possibly with ancillary video processing such as a video frame selector that chooses a frame or frame sequence to which the CV detector is applied based on some selection criterion (e.g. a frame brightness metric, maximum contrast in frame metric, or so forth).

While the video pattern detection nodes typically comprise trained CV detectors, the extension modules 66 (or other components of the CV engine 40) implementing other CV node types, such as video pattern relation nodes, video stream acquisition nodes, video camera control nodes, or so forth, typically do not incorporate a trained classifier, but rather may be programmed based on mathematical relations (geometrical rotation or translation relations, spatial relations such as “above”, “below”, temporal relations such as “before” or “after”, or similarity relations comparing pre-determined pattern features), known video camera control inputs, or so forth.

In the following, some illustrative examples are presented of some suitable implementations of a system of the type described with reference to FIGS. 1 and 2.

The illustrative system includes the BPM GUI 20, referred to in this example as a Vision Enabled Process Environment (VEPE), which includes specific CV language extensions 30 and BPM-type modelling support for bringing CV capabilities into the process modeling. The illustrative example includes the generation component (GEM) 24 that takes process models (or designs) created in the VEPE 20 and creates plain executable business process design models in a language understood by the BPM engine 22. The illustrative example employs a BPM suite using BPMN 2.0 to represent the nodes and flow connectors, and which includes CV extensions 32 added to the plain language elements using extensibility mechanisms of the standard BPMN 2 notation which provides extension points for its elements. The BPM engine 22, denoted in this example by the acronym “BPME”, interfaces with the CV engine 40 at runtime when the process model executes. The CV engine (CVE) 40 of this example uses a modular approach that employs expressivity and modularity for interfacing CV operations with BPM elements. The CVE 40 may be implemented as an application program interface (API) that the BPME 22 uses to leverage the CV capabilities.

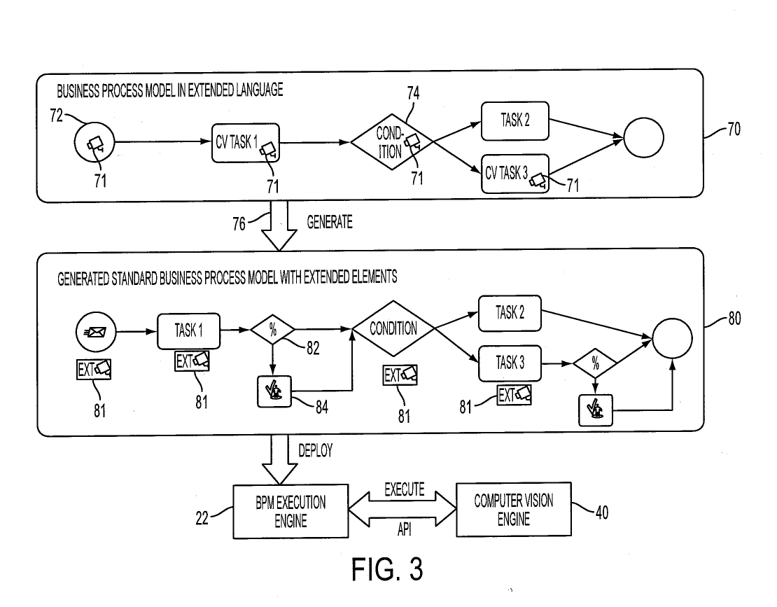

With reference to FIG. 3, a diagram of the foregoing example is presented. The process designer creates a process model 70 in the VEPE 20 using the extended language 30 that accommodates CV capabilities. The VEPE 20 is a graphical design editor for process models, which provides palettes of standard process elements as well as CV-enabled elements that the user can choose from to put into the diagram representing the process model. In the illustrative example of FIG. 3, the CV-enabled nodes are indicated by annotating a camera icon 71 to the node. In the example graphically represented process model 70 of FIG. 3, the starting element is a vision-event-based start node 72, and some of the tasks as well as a gateway node 74 are also vision-based. Task 2 is the only node not vision-based in this example, to illustrate the mix of process nodes with CV nodes. The process model 70 is translated by the GEM 24 in an operation 76 to translate the graphically represented process model 70 into an intermediate model 80 which, in this example, is standard BPMN that is enriched with extensions that pertain to the appropriate CV extensions. In the diagram 80 this is illustrated by a process containing only standard BPMN elements that have some extensions 81 annotated below the BPM nodes. These extensions are markers for API usage (that is, usage by the CVE 40 which is implemented in this example as an API) in the BPM engine 22, with properties attached that correspond to API parameters. This generated model suitably contains specific patterns automatically added in order to accommodate the uncertainty of the various CV events (in this example, a gateway 82 checking for the confidence level and deciding whether to involve a human validation represented by node 84). The generated process 80 is deployed onto the BPME engine 22 which employs the CVE 40 for tasks that require CV functionality by interpreting the markers and thus translating process semantics into CV operations.

The VEPE graphical modelling environment 20 can be implemented as a stand-alone process editor such as the open source Eclipse BPMN 2.0 Modeler, or incorporated into an existing BPM suite. If VEPE is a stand-alone editor, it should have enough process design functionality to cover the structural elements of normal process design and the CV nodes. In the stand-alone VEPE approach, most of the business functionality that is not CV-centric is enriched in a standard BPM editor at a later stage, after the GEM generation of the BPMN. On the other hand, if VEPE is designed as an extra layer on top of an existing BPM GUI, the CV extensions 30 provide the specific support for designing the CV processes in the form of additional dedicated tool palettes containing the CV elements, property sheets and configuration panels for the specification of the various parameters used by the CV elements, as well as any other graphical support to highlight and differentiate CV nodes from standard BPM elements. Additionally, a specific decorator for CV could be enabled (such as the illustrative camera icon 71 shown in FIG. 3) which, when applied to any supported BPM GUI process element (e.g. node) would transform it into a CV element. This could then be implemented in the graphical user interface by enabling the user to drag-and-drop the camera icon 71 onto a node, for example). In this case, the GEM 24 (and more particularly the CV extensions 32) suitably run in the background, constantly translating the vision elements into BPM elements, or alternatively run when the model is saved (or at other designated moments).

The language extensions 32 support the definition of process models that can take advantage of CV capabilities. The GEM 24 uses the extensions 32 in the generation phase. The CV language extensions 32 may comprise definitions of new elements or extending and customizing existing elements. Both approaches can be implemented in typical open source BPM suites, and some BPM languages are built with extensions in mind. For example, BPMN 2.0 has basic extension capabilities that allow the enrichment of standard elements with a variety of options. Where such extension capabilities do not suffice, new elements can be introduced. Both the additional elements and the extensions to the existing elements need to be supported by the BPME 22 by way of the CV extension modules 40 which execute the CV nodes of the generated process model.

The BPM engine 22 is suitably implemented as an application server that can interface with a variety of enterprise applications such as Enterprise Resource Planning (ERP) and/or Customer Relationship Management (CRM) directories, various corporate databases (e.g. inventory and/or stock databases, etc) and that can orchestrate and control workflows using high-performance platforms supporting monitoring, long-term persistence and other typical enterprise functionality. The CV systems and methods are implemented using the CV extensions 30, 32 and modules 40 disclosed herein, and additionally can advantageously leverage existing BPM suite capabilities through the disclosed CV extensions 30, 32 and CV engine/extension modules 40, for example using call-back triggering functionality. For open source BPM engines such as those of the Stardust, Bonita, and jBPM suites, the CV extension modules 40 are straightforward to implement due to the availability of the open source BPM code. For proprietary BPM suites, the CV extension models 40 can be added through specific APIs or another Software Development Kit (SDK) provided by the BPM suite vendor, for example leveraging a BPMN Service Tasks framework.

Adding the CV extension modules or other CV engine 40 to an existing BPM engine 22 entails adding connectivity to the CV Engine 40, for example using APIs of the CV engine 40 in order to provide the CV functionality specified in the language extensions 30, 32. Some CV language extensions may be natively supported, so that they are first class elements of the BPM engine 22 (for extensions that the GEM 24 cannot map to standard BPMN). Other CV language extensions may be implemented via an intermediate transformation operation in which the process model (e.g. process model 70 of FIG. 3) expressed with language extensions 71 is converted by the GEM 24 to conventional BPMN descriptions before being executed by the BPM engine 22. For instance in this case a CV task (e.g. represented by a node with a camera icon 71) is converted into a normal BPMN task with prefilled specific parameters and the BPM engine 22 executes this BPMN task as a normal task, by calling a web service provided by the CV Engine 40. This can be achieved through a BPMN Service Task prefilled with web service information that points to a specific web service that acts as a façade to the CV engine 40. A combination of native and intermediate transformation approaches may also be employed, where the GEM 24 generates an intermediate process model 80 in mostly standard BPMN and the BPM engine 22 has minimal extension modules to support CV operations that cannot be expressed as a prefilled BPMN Service Task or other process model language formalism of the BPM suite.

The Computer Vision (CV) Engine 40 provides the execution support for CV-enabled process models. In one illustrative embodiment, its functionality is divided in three (sub-)components: (1) native support for the Video Domain-Specific Language (VDSL) by allowing the specification of composite actions, patterns and associated queries using the elements specified in the VDSL; (2) call-back functionality for triggering actions in a process model when certain events are detected; and (3) a component allowing the specification of rules in the observed video scenes (to be then used for detecting conformance, compliance, and raising alerts).

A challenge in integrating CV capabilities in BPM relates to the handling of the inherent uncertainty that CV algorithms entail. This is a consequence of the complexity of a video data stream as compared with other types of typical inputs such as a manufacturing line sensor which typically produces a discrete output (e.g. parts count). In one approach, the detection of an event in a video stream is assigned an associated confidence level. This may be done, for example, based on the output of a “soft” CV classifier or regressor that outputs a value in the range (for example) of [0,1] with 0 indicating lowest likelihood of a match (i.e. no match) and 1 indicating highest likelihood of a match. In this case, a match may be reported by the CV classifier if the output is above a chosen threshold—and the match is also assigned a confidence level based on how close the classifier or regressor output is to 1.

In addition to constructing the CV classifier or regressor to provide an indication of the confidence level, the process model is suitably constructed to process a match based in part on this confidence level. For instance, in one approach if the CV classifier or regressor indicates a 99% confidence level that a certain event was detected, the process designer may consider that the risks that this is wrong at this high confidence level are minimal and therefore the process can assume the event was indeed detected. On the other hand, for a lower confidence value (say, 80%), the process designer may choose to add process logic in order to deal with the lower level of confidence in the event detection, for instance by executing additional tasks such as involving a human supervisor to double-check the data. In one approach, the process logic to deal with uncertainty is automatically added as part of the generation phase performed by the GEM 24 using the extensions 32, for any uncertainty-prone CV task. As such the process designer operating the BPM GUI 20 does not need to modify the gateway element to specify the confidence level, but rather specifies the confidence level directly onto the CV elements in the process model 70. These values are automatically transported at the generation phase into the generated BPMN model 80 that contains the gateway and compensation logic, configuring the gateway values automatically. This is illustrated in FIG. 3, where the gateway 82 checks for the confidence level and decides whether to involve a human validation represented by node 84—in the case of 99% confidence level the gateway 82 passes flow to the next gateway (labeled “Condition”), whereas for an 80% confidence level the gateway 82 passes flow to the manual verification node 84. The confidence level threshold used in the gateway 82 is suitably chosen by the process designer based on factors such as the impact of a false positive (detecting an event that is not actually in the video stream) compared with a false negative (failing to detect an event that is in the video stream); the possible adverse impact on the process of invoking human interaction at node 84; and so forth. In general, handling of uncertainty in CV tasks may depend on factors such as the nature of the task (e.g., critical tasks may need a higher degree of certainty as compared with less critical tasks), legal considerations (e.g. a CV operation to detain a suspected criminal by locking an exit door may require immediate involvement of law enforcement personnel to avoid a potential “false imprisonment” situation), cost-benefit analysis (e.g. the CV detection may be relied upon for quality control inspection of a high volume & low cost part, whereas human review may be called for upon detection of a possible defect in a low volume & high cost part), and so forth. It will be appreciated that these trade-offs are readily implemented by setting the threshold of the gateway 82. If appropriate, the process model may be constructed to invoke human intervention to verify every CV event detection (so that in the example of FIG. 34 flow always goes to node 84 and gateway 82 may be omitted), or alternatively may be constructed to never invoke human intervention (so that both gateway 82 and node 84 may be omitted). While described with reference to event detection, similar uncertainty considerations may apply to other CV nodes, such as video pattern relation nodes—as an example, manual check logic similar to the gateway 82/manual verification node 84 may be implemented for a video pattern relation node that detects two similar objects (for example, to implement facial recognition identification or some other video-based identification task).

In the disclosed approaches, the process designer does not need to program any connection between the process model implemented via the BPM suite and the CV engine 40. Rather, the process designer selects to use CV-enabled elements (e.g. nodes) in the process model, the connections to appropriate CV processing are made automatically by the CV extension modules 40, e.g. via CV engine APIs, BPMN Service Tasks prefilled with web service information, or the like. The CV engine 40 is modular. Various video patterns (e.g. persons, objects, or scenes) are individually described by corresponding video pattern detectors which are represented in the process model by video pattern detection nodes. Relationships (spatial, temporal, geometric transformational, similarity) between detected video patterns are recognized by video pattern relation nodes, which form a video grammar for expressing CV tasks in terms of a video vocabulary comprising the detectable video patterns. In this way, CV tasks can be composed on-the-fly for any process model. Composition mechanisms accessible through CV engine APIs are automatically employed by adding CV nodes to the process model. The modularity of this approach allows for the reuse and combination of any number of video patterns to model arbitrary events. The disclosed approach reduces CV task generation to the operations of selecting CV elements represented as CV nodes and designating CV node parameters and/or properties.

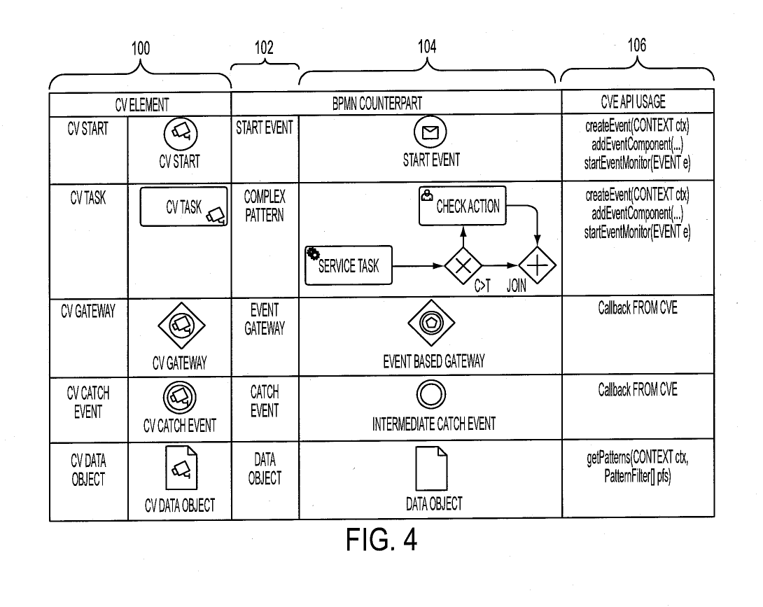

With reference now to FIG. 4, some illustrative CV nodes 100 (where the term “node” as used herein encompasses gateways) that may be provided by an embodiment of the CV extensions 30 of the BPM GUI 20 are shown for a illustrative operations 102, along with corresponding BPMN code 104 suitably generated by an illustrative embodiment of the CV extensions 32 of the BPM design language generation component 24 and API usage 106 suitably employed by an illustrative embodiment of the CV engine 40 of the BPM engine 22. The CV nodes 100 are made available in a CV palette provided by the BPM GUI 20, or they can be generated by adding the CV decorator (e.g. camera icon 71, see FIG. 3) onto existing standard BPMN nodes, thus changing their type to CV nodes. The CV nodes 100 have embedded CV semantics that ensure that at execution time, the BPME 22 is able to correctly execute them using the CVE 40.

The table shown in FIG. 4 lists illustrative CV elements showing the CV node 100 including its icon, the BPMN counterpart 104 and API usage indicator 106, pointing to an API that is leveraged to achieve the CV functionality represented by the corresponding CV node 100. FIG. 4 provides illustrative examples, and additional or other CV nodes are contemplated. For most CV nodes 100, the BPMN counterpart 104 is a BPMN node. It will be noted, however, that the illustrative CV Task node of FIG. 4 maps to more complex pattern BPMN counterpart logic accounting for uncertainty as already described. This example illustrates the variety of mappings that can be used. The BPMN mappings 104 are stored in a way that can be leveraged by the GEM 24, as the GEM 24 uses this information when generating BPMN from the process model with CV nodes 100 constructed using the BPM GUI 20.

With reference back to FIG. 1, after generating a vision-extended process model using the BPM GUI 20 and optional intermediate generation component 24, the BPM engine 22 leverages the visual information available from the video cameras 42 by querying the Computer Vision Engine (CVE) 40. In the following, internal components of an illustrative embodiment of the CVE 40 are described, which are based on a Video Domain-Specific Language (VDSL). A suitable embodiment of an external API of the CVE 40 is used to formulate queries from the BPM engine 22 to the CV engine 40.

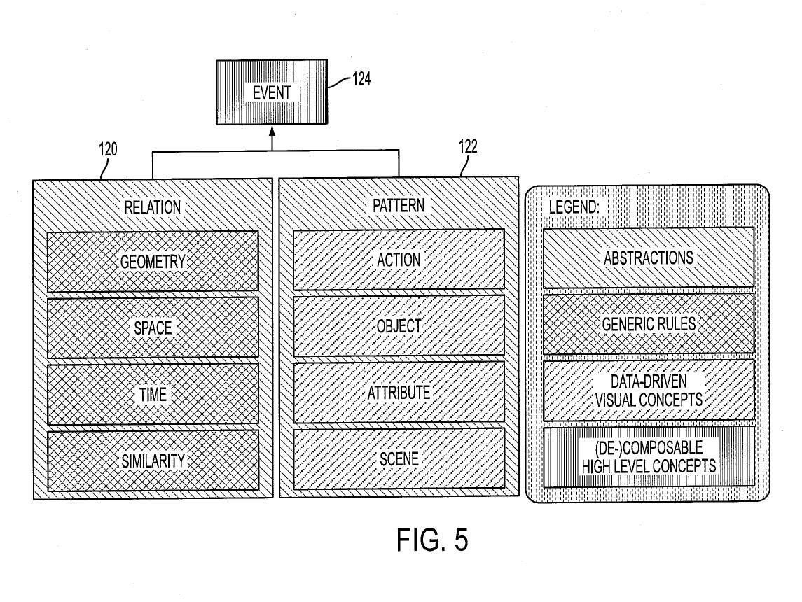

With reference now to FIG. 5, a diagram is shown of different elements of the illustrative VDSL, which employs a video grammar formalism to organize visual concepts in different entity categories (the vocabulary, i.e. detectable video patterns) and video pattern relation categories depending on their functional roles, their semantics, and their dependency on data. In the illustrative VDSL, detectable video patterns for persons, objects, or scenes are generally assumed to be static. To this end, a video pattern is detected using a single video frame or a short segment of the video data stream (e.g. a short “burst” of video, averaged to produce a representative “average” video frame representing the burst). Activities of the detected person or object (for example, temporal changes such as translational or rotational movement, or geometrical changes such as rotation) are processed by detecting the video pattern of the person or object in successive time intervals of the video data stream and then applying a video pattern relation CV node to these successively detected video patterns, usually in the context of a detected scene. A similarity video pattern relation node may initially be used to determine that the pattern detected in successive video segments is indeed the same object.

The “relations” category 120 of FIG. 5 is applicable to detected video patterns. Geometrical transforms (such as translation, scaling, rotation . . . ) can be quantitatively measured via image matching and optical flow estimation techniques. These video pattern relation nodes describe the motion of objects and reason about the dynamics of a scene. Pairwise spatio-temporal relations describe spatio-temporal arrangements between detected video patterns. They are used to reason about interactions between different persons or objects, or to represent the spatio-temporal evolution of a single object. Note that these generic rules (geometrical and spatio-temporal) are formalized a priori. The similarity video pattern nodes are measures of similarity of detected video patterns according to different predefined video features (e.g., colors).

The “patterns” category 122 of the illustrative VDSL formalism of FIG. 5 provides abstraction that unifies low-level video concepts such as actions, objects, attributes, and scenes, which are detectable video patterns. Actions are the verbs in the video grammar expressed by the VDSL, and are modelled using motion features. Persons or objects are the nouns, and are modelled by appearance (e.g., via edges, shape, parts . . . ). In some approaches, a person may be considered an “object”; however, the importance of persons in many CV tasks and the more complex activities a person may engage in (as compared with, for example, a vehicle which typically can only move along the road) motivates providing separate treatment for persons in the internals of the Computer Vision Engine 40. Attributes are adjectives in the video grammar, and correspond to properties of video patterns (such as color or texture). Scenes are semantic location units (e.g., sky, road . . . ).

Video patterns are data-driven concepts, and accordingly the video detector nodes comprise empirical video pattern detectors (e.g. video classifiers or regressors) that are trained on video examples that are labeled as to whether they include the video pattern to be detected. Some patterns are generic (e.g., persons, vehicles, colors, atomic motions . . . ), and can therefore be pre-trained using a generic training set of video stream segments in order to allow for immediate re-use across a variety of domains. However, using generically trained detectors may lead to excessive uncertainty. Accordingly, for greater accuracy in video pattern detector may be trained using a training set of domain-specific video samples, again labeled as to whether they contain the (domain-specific) pattern to be detected. The number of training examples may be fairly low in practice, depending on the specificity of the pattern (e.g., as low as one for near-duplicate detection via template matching, for example in a recognition task for facial recognition of a person, or license plate matching to identify an authorized vehicle). In some implementations, the video pattern detector may be trained on labeled examples augmented by weakly labeled or unlabeled data (e.g., when using semi-supervised learning approaches).

Events 124 formally represent high-level video phenomena that the CV engine 40 is asked to observe and report about according to a query from the BPM engine 22. In contrast to video patterns 122, models of events cannot be cost-effectively learned from user-provided examples. Events are defined at runtime by constructing an expression using the video grammar which combines video patterns 122 detected by empirical video pattern classifiers or regressors using video pattern relations 120. This expression (event) responds to a particular query from the BPM engine 22. Both specificity and complexity of queried events is accommodated by composition of empirically detected video patterns 122 using the grammatical operators, i.e. video pattern relations 120.

In the following, an illustrative API-based approach is described via which the BPM engine 22 formulates queries to the CV engine 40. These queries to the CV engine 40 are made during runtime execution of a process model that includes CV nodes connected by flow connectors which represent CV tasks expressed in the VDSL video grammar just described.

A Context object holds a specific configuration of the set of video cameras 42 and their related information. The Context object also incorporates constraints via a set of constraints from the BPM engine 22 (e.g., to interact with signals from other parts of the process model). The API allows filtering of the video streams processed (for instance to limit the video streams that are processed to those generated by video cameras in certain locations). This can be expressed by the following API queries:

Context={CameraInfo[ ] cis, BPConstraints[ ] bpls}

Context getContext(CameraFilter[ ] cfs, BPConstraints[ ] bpcs)

Pattern objects are entities comprising detectable visual patterns. They are accessible via the following API queries:

PatternType=Enum{Action, Object, Attribute, Scene}

Pattern={PatternType pt, SpatioTemporalExtent ste, Confidence c}

Pattern[ ] getPatterns(Context ctx, PatternFilter[ ] pfs)

The detectable video patterns (actions, objects, attributes, and scenes) are those video patterns for which the CVE 40 has a pre-trained video pattern detector. These video pattern detectors may optionally be coupled in practice (multi-label detectors) in order to mutualize the cost of search for related video patterns (e.g., objects that rely on the same underlying visual features). Pattern filter and context arguments allow searches for patterns verifying certain conditions.

Relations describe the interaction between two patterns:

RelationType=Enum{Geometry, Space, Time, Similarity}

Relation={RelationType rt, RelationParameter[ ] rps, Confidence c}

Relation[ ] getRelations(Pattern p1, Pattern p2)

The Geometry, Space, Time, and Similarity relation types correspond respectively to a list of predetermined geometrical transformations (e.g., translation, rotation, affine, homography), spatial relations (above, below, next to, left to . . . ), temporal relations (as defined, for example, in Allen's temporal logic), and visual similarities (e.g., according to different pre-determined features). The video pattern relations are defined a priori with fixed parametric forms. Their parameters can be estimated directly from the information of two patterns input to the video pattern relation node.

Events enable hierarchical composition of patterns and relations in accordance with the video grammar in order to create arbitrarily complex models of video phenomena, such as groups of patterns with complex time-evolving structures. Events are internally represented as directed multi-graphs where nodes are video patterns and directed edges are video pattern relations. Two nodes can have multiple edges, for instance both a temporal and a spatial relation. Events are initialized from a context (suitably detected using a video pattern detection node trained to detect the context pattern), and are built incrementally by adding video pattern relations between detected video patterns. Some illustrative API queries are as follows:

```
Event createEvent(Context ctx)
Event addEventComponent(
  Event e,
  Pattern p1, int id1,
  Pattern p2, int id2,
  Relation[ ] rs)
```

(these API calls add two pattern nodes with specified IDs and relations to the event)

CallbackStatus startEventMonitor(Event e)

(instructs the CVE 40 to send notifications each time an event happens)

stopEventMonitor(Event e)

In the following, examples are presented of illustrative API calls that might be generated by the illustrative embodiment of the GEM 24, and handled as per the process execution by both the BPM engine 22 and the CV engine 40. These API calls are listed sequentially below, but, in practice they would be part of complex process model interactions, and may be interleaved with other process elements.

The following example describes a CV task performing illegal U-turn (“iut”) enforcement. In this transportation example, the goal is to monitor intersections of a camera network for illegal U-turns.

Context ctx = CVE.getContext(CameraFilter(“has_u_turn_restrictions”))
Event iut = CVE.createEvent(ctx)
CVE.addEventComponent(
iut,

| | |
|---|---|
| Pattern(Object, “car”), 0, | // a car is detected |
| Pattern(Object, “car”), 1, | // a second car is detected |
| [Relation(Time, [“after”, “1s”]) | // detections are 1 second apart |
| Relation(Similarity, [“identical”]), | // they correspond to the same car |

```
    Relation(Geometry, [“translation”])]) // undergoing a translation
CVE.addEventComponent(
  iut,
  Pattern(Object, “car”), 1,
  Pattern(Object, “car”), 2,
  [Relation(Time, [“after”]),
```

| | |
|---|---|
| Relation(Similarity, [“identical”]), | // still the same car |

Relation(Geometry, [“rotation”, 180])]), // undergoing a 180° rotation
CVE.startMonitorEvent(iut)

In this example, the “car” video pattern detector is applied in two successive intervals with a temporal relation of being spaced apart by one second (parameter “1s”) and having the similarity relation of being “identical” (where “identical” is defined by some suitably close correspondence of features; the similarity relation may also apply a spatial registration operation to spatially register the two car video patterns prior to comparing the features). The first geometry relation (“translation”) determines that the car is in motion, while the second geometry relation (“rotation”, operating on second and a third detected car video pattern again found to be identical by the similarity relation) determines the car has undergone a 180° rotation, i.e. has made a U-turn. Because this processing is applied only to cameras operating where there are U-turn restrictions (as per the first line, Context ctx= . . . ), it follows that this detected 180° turn is an illegal U-turn. This triggers the startMonitorEvent(iut) which may be represented in the process diagram by a CV gateway, and the startMonitorEvent(iut) may for example be a second CV event that captures the license plate of the vehicle, which may then flow into non-CV BPMN logic that accesses a license plates database (e.g., one of the databases 34 of FIG. 1) to obtain the car registration flowing into further non-CV BPMN logic that causes the issuance of a citation to the car owner. This latter may include logic that uses information obtained by the CV events, for example to include a video frame showing the vehicle license plate in the issued iut citation.

The following further example describes a CV task performing red light enforcement. In this example, the goal is to monitor traffic lights for red light enforcement (i.e., to detect vehicles that illegally go through a red light).

```
Context ctx = CVE.getContext(CameraFilter(“has_red_traffic_light”))
Event rle = CVE.createEvent(ctx)
CVE.addEventComponent(
  rle,
  Pattern(Object, “traffic_light”), 0,
  Pattern(Scene, “road”), 1,
  [Relation(Space, [“before”])])
CVE.addEventComponent(
  rle,
  Pattern(Object, “traffic_light”), 0,
  Pattern(Scene, “road”), 2,
  [Relation(Space, [“after”])])
CVE.addEventComponent(
  rle,
  Pattern(Object, “car”), 3,
  Pattern(Object, “road”), 1,
  [Relation(Space, [“on”])])
CVE.add EventComponent(
  rle,
  Pattern(Object, “car”), 4,
  Pattern(Object, “road”), 2,
  [Relation(Space, [“on”])])
CVE.add EventComponent(
  rle,
  Pattern(Object, “car”), 3,
  Pattern(Object, “car”), 4,
  [Relation(Similarity, [“identical”]), // actually the same car
  Relation(Time, [“after”])]) // car4 detected after car3
CVE.startMonitorEvent(rle)
```

As already mentioned, the disclosed agile computer vision task development and execution platform may employ a commercial and/or open-source BPM suite including a BPM GUI 20 with CV extensions 30, a BPM engine 22 in operative communication, e.g. via API or the like, with a CV engine 40, and optional intermediary BPM design language generation component(s) 24 with CV extensions 32. It will be further appreciated that the disclosed agile development and execution platform for developing and executing processes that include CV functionality may be embodied by a non-transitory storage medium storing instructions readable and executable by an electronic system (e.g. server 18 and/or computer 16) including a graphical display device 10, at least one user input device 12, 14, and at least one processor to perform the disclosed development and execution of processes that include CV functionality. The non-transitory storage medium may, for example, include a hard disk drive, RAID, or other magnetic storage medium; an optical disk or other optical storage medium; solid state disk drive, flash thumb drive or other electronic storage medium; or so forth.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A Business Process Management (BPM) system comprising:
a graphical display device;
at least one user input device; and
at least one processor programmed to:
implement a BPM graphical user interface (GUI) enabling a user to operate the at least one user input device to construct a process model that is displayed by the BPM GUI on the graphical display device, the BPM GUI providing (i) nodes to represent process events, activities, or decision points including computer vision nodes to represent video stream processing and (ii) flow connectors to define operational sequences of nodes and data flow between nodes;
implement a BPM engine configured to execute a process model constructed using the BPM GUI to perform a process represented by the process model; and
implement a computer vision engine configured to execute a computer vision node of a process model constructed using the BPM GUI by performing video stream processing represented by the computer vision node.

2. The BPM system of claim 1 wherein the BPM GUI displays the process model using Business Process Model Notation (BPMN) to represent the nodes and flow connectors and further using computer vision extension notation to represent computer vision nodes.

3. The BPM system of claim 1 wherein the computer vision engine comprises computer vision extension modules of the BPM engine.

4. The BPM system of claim 1 wherein:
the BPM GUI provides computer vision nodes including a plurality of video pattern detection nodes for different respective video patterns; and
the computer vision engine is configured to execute a video pattern detection node of a process model constructed using the BPM GUI by applying a classifier trained to detect a video pattern corresponding to the video pattern detection node in a video stream that is input to the video pattern detection node via a flow connector.

5. The BPM system of claim 4 wherein the different respective video patterns include video patterns of persons, objects, and scenes.

6. The BPM system of claim 4 wherein:
the BPM GUI provides computer vision nodes including a plurality of video pattern relation nodes designating different respective video pattern relations; and
the computer vision engine is configured to execute a video pattern relation node of a process model constructed using the BPM GUI by determining whether two or more video patterns detected by execution of one or more video pattern detection nodes satisfy the video pattern relation designated by the video pattern relation node.

7. The BPM system of claim 6 wherein the different respective video pattern relations include geometric transform relations, spatial relations, temporal relations, and similarity relations.

8. The BPM system of claim 1 wherein the computer vision nodes provided by the BPM GUI include:
a set of video pattern detection nodes defining a video vocabulary of video patterns of persons, objects, and scenes; and
a set of video pattern relation nodes defining a video grammar of geometrical, spatial, temporal, and similarity relations between video patterns detectable by the set of video pattern detection nodes;
wherein the BPM GUI enables a user to operate the at least one user input device to construct a computer vision process model comprising computer vision nodes interconnected by flow connectors in compliance with the video grammar defined by the set of video pattern relation nodes.

9. The BPM system of claim 1 wherein:
the BPM GUI further provides a video stream acquisition node to represent acquisition of a video stream; and
the computer vision engine is further configured to execute a video stream acquisition node by acquiring a video stream.

10. The BPM system of claim 9 wherein:
the BPM GUI further provides a video camera control node to represent a video camera control operation; and
the computer vision engine is further configured to execute a video camera control node by controlling a video camera to perform the video camera control operation.

11. The BPM system of claim 9 further comprising:
a video camera;
wherein the computer vision engine is configured to execute a video stream acquisition node associated with the video camera by acquiring a video stream using the video camera.

12. A non-transitory storage medium storing instructions readable and executable by an electronic system including a graphical display device, at least one user input device, and at least one processor to perform a method comprising the operations of:
(1) providing a graphical user interface (GUI) by which the at least one user input device is used to construct a process model that is displayed on the graphical display device as a graphical representation comprising (i) nodes representing process events, activities, or decision points and including computer vision nodes representing video stream processing and (ii) flow connectors connecting nodes of the process model to define operational sequences of nodes and data flow between nodes of the process model; and
(2) executing the process model to perform a process represented by the process model including executing computer vision nodes of the process model by performing video stream processing represented by the computer vision nodes of the process model.

13. The non-transitory storage medium of claim 12 wherein the graphical representation uses Business Process Model Notation (BPMN) to represent the nodes and flow connectors of the process model and further uses computer vision extension notation to represent the computer vision nodes of the process model.

14. The non-transitory storage medium of claim 12 wherein the computer vision nodes of the process model include a video pattern detection node and the operation (2) comprises:
executing the video pattern detection node by applying a classifier trained to detect a video pattern targeted by the video pattern detection node in a video stream input to the video pattern detection node via a flow connector of the process model.

15. The non-transitory storage medium of claim 14 wherein the video pattern targeted by the video pattern detection node is a video pattern of a person, object, or scene.

16. The non-transitory storage medium of claim 14 wherein the method comprises the further operation of:
(0) training the classifier to detect the video pattern targeted by the video pattern detection node using video examples each labeled as to whether the video pattern targeted by the video pattern detection node is present in the video example.

17. The non-transitory storage medium of claim 12 wherein the computer vision nodes of the process model include a first video pattern detection node, a second video pattern detection node, and a video pattern relation node connected by flow connectors of the process model to receive inputs from the first and second video pattern detection nodes, and the operation (2) comprises:
executing the first video pattern detection node by applying a classifier trained to detect a video pattern targeted by the first video pattern detection node to detect a first video pattern instance in a video stream;
executing the second video pattern detection node by applying a classifier trained to detect a video pattern targeted by the second video pattern detection node to detect a second video pattern instance in the video stream; and
executing the video pattern relation node to detect a relation, targeted by the video pattern relation node, between the first video pattern instance and the second video pattern instance.

18. The non-transitory storage medium of claim 17 wherein the relation targeted by the video pattern relation node is one of a geometric transform relation, a spatial relation, a temporal relation, and a similarity relation.

19. The non-transitory storage medium of claim 12 wherein the operation (1) comprises:
(1) providing the GUI by which the at least one user input device is used to construct a process model that is displayed on the graphical display device as a graphical representation comprising computer vision nodes selected from:
a set of video pattern detection nodes defining a video vocabulary of video patterns of persons, objects, and scenes; and
a set of video pattern relation nodes defining a video grammar of geometrical, spatial, temporal, and similarity relations between video patterns detectable by the set of video pattern detection nodes;
wherein the GUI constructs the process model with the computer vision nodes interconnected by flow connectors in compliance with the video grammar defined by the set of video pattern relation nodes.

20. A system comprising:
a non-transitory storage medium as set forth in claim 12; and
a computer including a graphical display device and at least one user input device, the computer operatively connected to read and execute instructions stored on the non-transitory storage medium.
